(19) United States
(12) Patent Application Publication
(10) Pub. No.: US 2015/0300957 A1
(43) Pub. Date: Oct. 22, 2015

(54) SAMPLE HOLDER AND SYSTEM FOR USING

(71) Applicant: NANOSCOPIA (CAYMAN), INC., Grand Cayman (KY)

(72) Inventor: KENNETH EDWARD SALSMAN, PLEASANTON, CA (US)

(21) Appl. No.: 14/693,797

(22) Filed: Apr. 22, 2015

Related U.S. Application Data
(60) Provisional application No. 61/982,704, filed on Apr. 22, 2014.

(51) Int. Cl. G01N 21/75; B01L 3/00

(52) U.S. Cl. CPC G01N 21/75; B01L 3/502; B01L 2200/10; B01L 2400/0475; B01L 2300/123; B01L 2400/043

(57) ABSTRACT

A sample holder that includes a clamshell case, wherein one half of the clamshell includes a sample receiving port and a passageway there from that leads to one or more test chambers, each having an external window therein for external imaging (e.g., by a digital microscope). The test chamber may be a part of the clamshell apparatus, or may append there from. The first half of the clamshell may also include a reagent pack with a pressure breakable seal. The second half of the clamshell may have one or more extruded forms that act as a mechanical RAM when the clamshell is closed to compress the reagent pack and or the sample receiving port, so as to force fluid through the passageway to the test chamber. The reagent and the reagent pack may be forced into the sample receiving port and into the passageway along with the sample. The test chambers may have been lines leading to an overflow reservoir, which may have an air vent to the exterior of the sample holder.

### CROSS REFERENCE

This application claims the benefit of U.S. Provisional Pat. App. No. 61/982,704 filed Apr. 22, 2014, entitled “Handheld Diagnostic System with Sample Holder and Chip-Scale Microscope,” which is hereby incorporated by reference into this application.

### BACKGROUND

The disclosure herein relates generally to techniques and equipment that may be used in testing humans for diseases, such as malaria. Malaria is a mosquito-borne infectious disease that is prevalent in tropical and subtropical regions that are present in a wide band around the equator. Many of these areas are in underdeveloped countries. Testing for the disease and treatment thereof have proved to be challenging.

Digital microscopes have recently come into favor in such applications. Of course, such digital microscopes need to be portable, and able to withstand a harsh outdoor environment of high temperature, high humidity, and inconsistent access to sanitary facilities/conditions. Together, these and other issues present significant challenges to the various steps of obtaining samples, placing samples into sample holders, performing the wet chemistry necessary for treatment of the sample prior to analysis, and performing the microscope analysis.

What is needed, therefore, is a design that is better able to hold up to such challenges.

### SUMMARY

Disclosed herein is a sample holder that includes: a sample receiving port; a test chamber; a first passageway placing the sample receiving port in fluid communication with the test chamber; and an actuator associated with the sample receiving port that, when actuated, forces fluid therein into the first passageway and test chamber.

The sample receiving port may have a first volume when in a relaxed state, and wherein the actuator is a mechanical actuator that reduces the volume of the sample receiving port to a volume less than the first volume to force fluid therein into the first passageway and test chamber. The mechanical actuator may include a mechanical ram that is sized and positioned to reduce the volume of the sample receiving port when actuated. The sample receiving port may be defined in a sample holder body and the mechanical ram is associated therewith. The mechanical ram may be part of a mating body portion that can be actuated relative to the sample holder body to reduce the volume of the sample receiving port. The mating body portion may be pivotally attached to the sample holder body. The mating body portion may be pivotally attached to the sample holder body via a hinge. The mating body portion and the sample holder body may each be part of a clamshell arrangement. When the mechanical actuator is actuated, the mechanical ram may be urged by a spring toward the sample receiving port.

The sample may further include a reagent storage chamber containing chemical reagent, the storage chamber being in fluid communication with the sample receiving port via a second passageway containing a pressure-breakable seal; wherein the actuator includes a mechanical ram that is sized and positioned to reduce the volume of the reagent storage chamber when actuated, which forces reagent into the second passageway, breaks the seal, forces reagent into the sample receiving port, and forces both the reagent and the sample into the first passageway and test chamber.

The sample holder may further include a particle filter in the first passageway. There may be a plurality of test chambers all in fluid communication with the first passageway. The sample holder may further include an overflow reservoir in fluid communication with the test chamber to receive excess fluid. The test chamber may be in fluid communication with the overflow reservoir via a vent line. The overflow reservoir may have an indicator associated therewith to indicate to a user that fluid has reached the overflow reservoir. The sample holder may further include a gas vent allowing gas to escape from the overflow reservoir to the ambient atmosphere.

The test chamber may have a window to allow the contents therein to be viewed or imaged from the exterior of the sample holder.

The sample holder may further include a first thermal agent storage chamber having a second volume when in a relaxed state, the first thermal agent storage chamber containing a first thermal agent and being in fluid communication with a thermal chamber positioned adjacent to but not in fluid communication with the test chamber, the thermal chamber containing a second thermal agent therein; and wherein the mechanical actuator, in addition to reducing the volume of the sample receiving port, when actuated, reduces the volume of the thermal agent storage chamber to a volume less than the second volume to force fluid therein into the thermal chamber, the first thermal agent reacting in the thermal chamber with the second thermal agent to create a chemical reaction that changes the temperature of the test chamber.

A thermal conductor may be located between the thermal chamber and the test chamber. The thermal chamber may include a second thermal agent storage chamber containing the second thermal agent, a third thermal agent storage chamber containing a third thermal agent, and a mixing chamber in fluid communication with the second thermal agent storage chamber and with the third thermal agent storage chamber, and wherein the first thermal agent storage chamber is in fluid communication with both the second thermal agent storage chamber and the third thermal agent storage chamber.

The mixing chamber may receive a product of the chemical reaction between the first thermal agent and the second thermal agent from the second thermal agent storage chamber and a product of the chemical reaction between the first thermal agent and the third thermal agent from the third thermal agent storage chamber. The thermal chamber may further include a first valve between the second thermal agent storage chamber and the mixing chamber and a second valve between the third thermal agent storage chamber and the mixing chamber, and wherein the valves can be separately controlled to mix a selected amount of the product from the second thermal agent storage chamber with a selected amount of the product from the third thermal agent storage chamber.

The thermal chamber may further include a thermal control unit that measures the temperature in the mixing chamber and controls the first and second valves in accordance with the measured temperature. The thermal control unit may include a bimetal bolometer.

An endothermic chemical reaction may occur between the first thermal agent and the second thermal agent and an exothermic reaction occurs between the first thermal agent and the third thermal agent. An endothermic chemical reaction may occur between the first thermal agent and the second thermal agent. An exothermic reaction may occur between the first thermal agent and the third thermal agent.

The mechanical actuator may include a magnet, a ferromagnetic fluid in an actuation chamber, and a flexible membrane separating the actuation chamber from one or both of the sample receiving port and the first passageway, wherein the magnet selectively acts on the ferromagnetic fluid to deform the membrane and force fluid movement in one or both of the sample receiving port and the first passageway. The magnet may be moved by the operator. The magnet may be moved by a spring. The magnet may be moved by a motor.

The sample holder may further include a thermal actuator that cycles the temperature of the test chamber between at least two different temperature levels. The first passageway passes through at least two different zones in the sample holder that are at different temperature levels from each other. The passageway may loop between the at least two different zones a plurality of times. The passageway may have a serpentine shape. The passageway may have a spiral shape. The passageway may have a helical shape. The flow rate may be controlled so that the fluid spends a predetermined amount of time in each different zone.

The actuator may be a centrifugal actuator associated with the sample receiving port that, when actuated, forces fluid in the sample receiving port into the first passageway and test chamber via centrifugal force. The actuator may be a gas pressure actuator associated with the sample receiving port that, when actuated, forces fluid in the sample receiving port into the first passageway and test chamber via gas pressure. The gas pressure actuator may include two substances that are combined together to cause a chemical reaction that releases gas.

Disclosed herein is a sample holder that includes: a test chamber into which a fluid sample can be introduced; a first thermal agent storage chamber having a first volume when in a relaxed state, the first thermal agent storage chamber containing a first thermal agent and being in fluid communication with a thermal chamber positioned adjacent to but not in fluid communication with the test chamber, the thermal chamber containing a second thermal agent therein; and a mechanical actuator that, when actuated, reduces the volume of the thermal agent storage chamber to a volume less than the first volume to force fluid therein into the thermal chamber, the first thermal agent reacting in the thermal chamber with the second thermal agent to create a chemical reaction that changes the temperature of the test chamber.

Disclosed herein is a sample holder that includes: a sample receiving port; a test chamber having a first transmissive window on one side of the chamber and a second transmissive window on another side of the chamber; and a first passageway placing the sample receiving port in fluid communication with the test chamber.

Disclosed herein is a system that includes: a sample holder that includes a sample receiving port, a test chamber having a first transmissive window on one side of the chamber and a second transmissive window on another side of the chamber, and a first passageway placing the sample receiving port in fluid communication with the test chamber; an illuminator that emits light that is directed into the first transmissive chamber of the test chamber; and an image sensor that produces an image from light that passes through the second transmissive chamber of the test chamber.

The light source and image sensor may be located in a test module, wherein the test module includes a port for receiving the sample holder. The illuminator may include a light source that generates light directed along a first axis, wherein the first transmissive window of the test chamber and the second transmissive window of the test chamber are aligned so that light passing along a second axis passes therethrough, wherein the first axis and the second axis are orthogonal to each other. The illuminator may include a fold mirror to redirect the generated light from the first axis to the second axis. The system may further include one or more spectral filters therein that filter light passing therethrough. The spectral filters may be removable via a filter port.

Disclosed herein is a method that includes: providing a sample holder having a sample receiving port, an actuator, and a test chamber; providing an analysis module; placing a human sample into the sample receiving port; actuating the actuator to move at least a portion of the sample into the test chamber; and inserting the sample holder into the analysis module. The analysis module analyzes the contents of the test chamber after the sample holder is inserted into the analysis module.

### BRIEF DESCRIPTION OF THE DRAWINGS

The disclosure herein is described with reference to the following drawings, wherein like reference numbers denote substantially similar elements:

FIG. 1 is a simplified illustration of a clamshell arrangement for a sample holder showing a mechanical ram that acts on a reagent pack to force fluid from the reagent pack into a sample receiving port and data passageway to plurality of test chambers.

FIG. 2 is a cross-sectional view of the mechanical ram portion of the sample holder of FIG. 1.

FIG. 3 is a cross-sectional view of the test chamber portion of the sample holder of FIG. 1.

FIG. 4 is a system for analyzing the contents of a test chamber of a sample holder, such as the sample holder of FIG. 1.

FIG. 5 is a simplified illustration of a clamshell arrangement for a sample holder showing both the mechanical ram for acting on a reagent pack, as shown in FIG. 1, and a mechanical ram for acting on a thermal reaction fluid pack that forces liquid into a pair of thermal agent storage chambers.

FIG. 6 is a simplified illustration of a thermal generation device.

FIG. 7 is a simplified illustration of a thermal reaction management system.

FIG. 8 is a simplified illustration of a thermal cycling and reaction system.

FIG. 9 is a perspective view of the sample holder of FIG. 1.

FIG. 10 is a simplified flowchart of methods for using the sample holder and system described herein.

FIG. 11 is a simplified illustration of us temperature cycling system with a spiral-shaped passageway.

### DETAILED DESCRIPTION

While the embodiments disclosed herein are susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives of embodiments of the invention as defined by the claims. The disclosure is described with reference to the drawings, wherein like reference numbers denote substantially similar elements.

Disclosed herein are techniques and systems related to an improved sample holder that allows the sample to undergo wet chemistry and be analyzed through an external window, without contaminating the sample. The techniques include forcing fluids from a reagent pack and a sample receiving port into one or more test chambers and controlling the temperature of the sample with thermal agents that can be forced between different chambers as desired to create endothermic or exothermic chemical reactions and control the temperature of the sample.

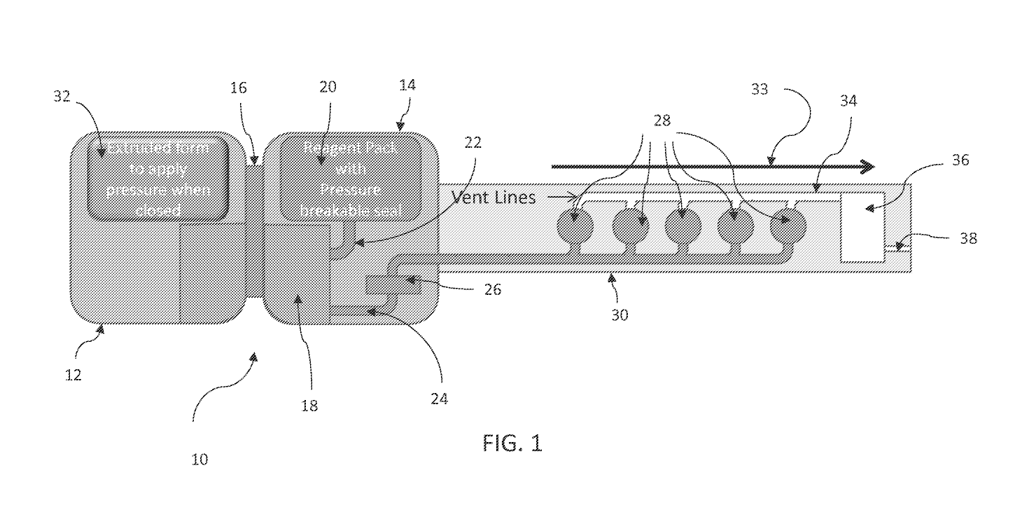

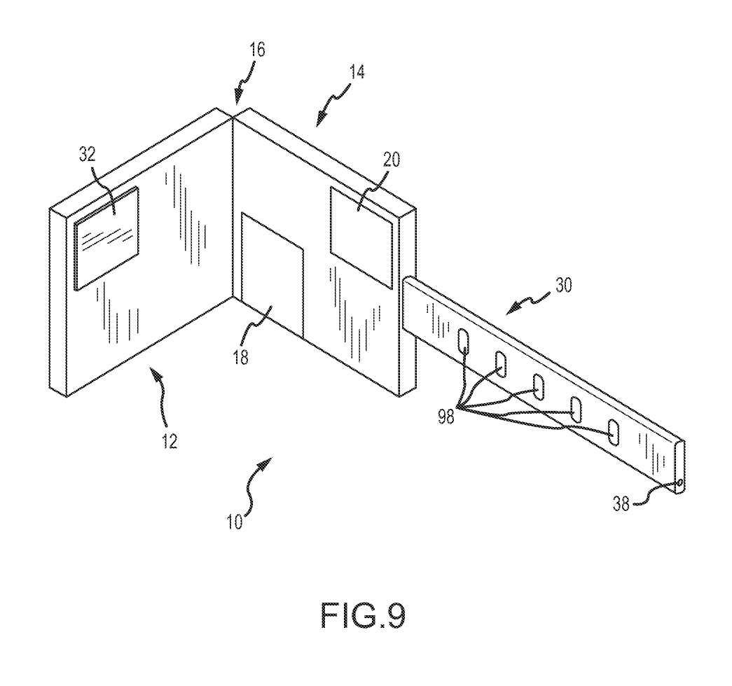

FIGS. 1 and 9 show incorporation of reagents within a sealed sample holder from microscopic/microscale analysis and diagnostics. Shown are a clamshell arrangement 10 that includes a first portion 12 of the clamshell 10 attached to a second portion 14 of the clamshell 10 by a hinge 16. The clamshell arrangement allows for simple insertion of a swab containing a sample and manual activation of a reagent. A sample receiving port 18 is provided in the second portion 14 to allow an operator to introduce a fluid or other sample therein. The port may include a swab sample insertion tray with the capability to snap off the swab handle and sealed the tray. A reagent pack 20 containing a reagent is in fluid communication with the sample receiving port 18 via a passageway 22. Optionally, a pressure-breakable seal may be provided in the reagent pack 20, the passageway 22, or the sample receiving port 18, to allow reagent to be forced from the reagent pack 20 into the sample receiving port 18, upon the application of a mechanical force thereto.

The sample receiving port 18 of the second portion 14 is in fluid communication via a passageway 24 with a plurality of test chambers 28 that may be provided within the second portion 14 or in an appended portion 30, as shown in FIG. 1. Optionally, a particle filter 26 may be located in the passageway 24. Although not shown, each of the test chambers may include an added dry agent, and it is possible that each chamber may contain a different type of agent.

The first portion 12 of the clamshell 10 includes a mechanical ram 32, shown in FIG. 1 as an extruded form, which applies a mechanical force to the reagent pack 20 when the first portion and second portion 14 are pivoted relative to each other to close the clamshell 10. This mechanical force from the mechanical ram 32 acting on the reagent pack 20 tends to reduce the volume of the reagent pack 20, thus forcing reagent from the reagent pack 20 through the passageway 22 into the sample receiving port 18. Further, the mechanical force can force the reagent from the reagent pack 20 and the fluid introduced into the sample receiving port 18 into the passageway 24, through the particle filter 26, and into the plurality of test chambers 28. As can best be seen in FIG. 9, the test chambers 28 each have a transmissive window 98 on one side of the appended portion 30 and each also have a transmissive window on an opposite side of the appended portion 30. With each test chamber 28 having such a pair of windows 98, illumination light can be directed into one side of the test chamber and an image sensor can create an image from light emanating through the window 98 on the other side.

Optionally, the appended portion 30 may also include vent lines 34 which provide for overflow of fluid from the plurality of test chambers 28 into an overflow reservoir 36. Further, the overflow reservoir 36 may be provided with an air vent 38 to vent air or other gases to the ambient atmosphere. Although not shown, the overflow reservoir may be provided with a liquid lock to prevent spillage. Also, a color indicator may be provided to alert the user that the sample holder is full.

An arrow 33 shows the direction of motion of the sample holder 10 when it is being inserted into an analysis module. The analysis module can be arranged to capture images as the sample holder 10 is being inserted therein or removed therefrom, or to capture images after the sample holder has been fully inserted therein.

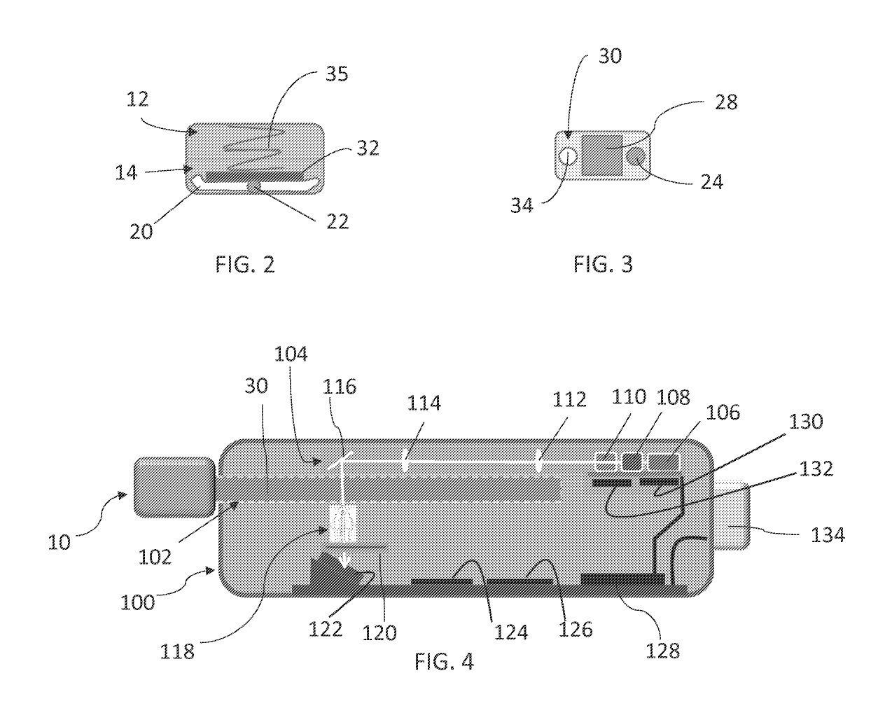

The cross-sectional view of FIG. 2 shows the mechanical ram 32 being urged outward by a spring 35. As can be seen, the spring 35 is mounted in the first portion 12 of the clamshell 10, underneath the ram 32. When the portions 12 and 14 of the clamshell 10 are moved relative to each other to close the clamshell 10, the ram 32 is forced into engagement with the reagent pack 20 and the fluid is driven through passageway 22, out of the reagent pack 20.

The cross-sectional view of FIG. 3 shows one of the test chambers 28 and the appended portion 30, as well as the passageway 24 and vent lines 34.

FIG. 4 shows an analysis module 100 having a receiving port 102 into which the appended portion 30 of the clamshell 10 has been inserted. The module 100 may include an illuminator 104 that may be easily removable by the operator and interchangeable with other illuminators. In this case, the illuminator includes one or more light sources 106, 108, and 110 which may provide broad-spectrum illumination light or selected bands of illumination light at particular wavelength ranges (e.g., red, green, and blue), or some combination thereof. The light from the light source(s) then passes through one or more lenses or other optical components 112 and 114 where it impinges upon a fold mirror 116. The fold mirror 116 redirects light from a first axis within the illuminator 104 to a second, orthogonal axis, for passing through the windows 98 of the sample holder 10. The light that passes through the sample holder 10 impinges upon an optical arrangement 118 and interchangeable spectral filter(s) 120, before impinging upon the image sensor 122. Various electronic devices 124, 126, 128, 130, and 132 may be provided for controlling the illuminator 104 and image sensor 122 and for initial processing of the image data. A communications and power component 134 may also be provided.

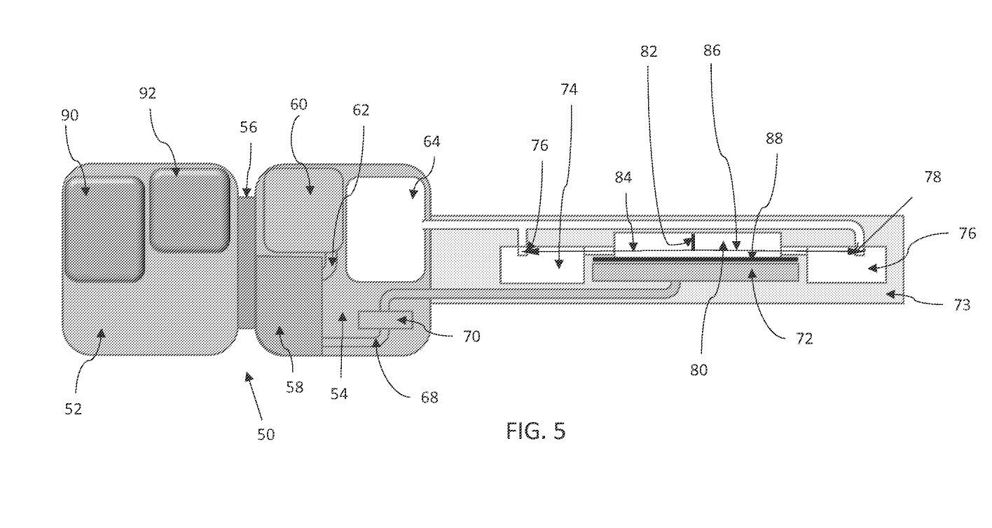

FIG. 5 shows incorporation of a rapid heating and cooling system within a sample holder. A sample holder in a clamshell arrangement 50 includes a first portion 52 connected to a second portion 54 by a hinge 56. The second portion 54 includes a sample receiving port 58 (into which fluid samples for test/analysis can be placed) and a reagent pack 60 (containing reagent) that is in fluid communication with the sample receiving port 58 via a passageway 62. In a similar manner to FIG. 1, a pressure-breakable seal may also be provided. The second portion 54 also includes a first thermal agent storage chamber 64 and a passageway 66 in fluid communication therewith. The first thermal agent storage chamber 64 may also be provided with a pressure-breakable seal.

The sample receiving port 58 is in fluid communication via a passageway 68 and particle filter 70 with a test chamber 72 that may be provided and the second portion 54 of the clamshell 50 or may be provided in an appended portion 73, as shown in FIG. 2. The passageway 66 places the first thermal agent storage chamber 64 in fluid communication with both a second thermal agent storage chamber 74 and a third thermal agent storage chamber 76. The flow of the first thermal agent from the first thermal agent storage chamber 64 to each of the second and third thermal agent storage chambers 74 and 76 is controlled by a flow control valve 76 and a flow control valve 78, respectively. A thermal mixing chamber 80 is in fluid communication with each of the second thermal agent storage chamber 74 and the third thermal agent storage chamber 76. A bimetal bolometer thermal control (or controller) 82 is associated with the thermal mixing chamber 80 to measure the temperature thereof and control the flow control valves 76 and 78. Valve linkages 84 and 86 are one example of how the valves 76 and 78 could be controlled by the thermal control 82. A thermal conductor 88 is located between and separates the thermal mixing chamber 80 from the test chamber 72.

The first half 52 of the clamshell 50 includes a pair of mechanical rams 90 and 92 (which may also be spring-loaded like in the sample holder 10) that are sized and positioned to engage with the first thermal agent storage chamber 64 and the reagent pack 60 in the second half 54 of the clamshell 50, when the two portions 52 and 54 are pivoted relative to each other about the hinge 56. When this occurs, the mechanical rams 90 and 92 reduce the volume of the first thermal agent storage chamber 64 and reagent pack 60, respectively, so as to force the first thermal agent out of the first thermal agent storage chamber 64 into the passageway 66 and, with the cooperation of flow control valve 76 and 78, into second thermal agent storage chamber 74 and third thermal agent storage chamber 76, respectively. Similarly, the mechanical force from the ram 92 against the reagent pack 60 forces reagent therein through the passageway 62 and into the sample receiving port 58 where the reagent and the fluid sample are passed via the passageway 68 and filter 70 into the test chamber 72.

The thermal conductor 88 can be a simple metal. For example, it could include anything that provides a rapid transfer of a temperature from one side of itself to the other side, or along its length. It is used not only to provide a better link to the hot or cold fluid from the thermal mixing chamber to the test chambers, but to also provide a more uniform heating along the sample flow path so that even though the thermal reaction fluid may be at a slightly different temperature at its entry point than when it is at the opposite end, and flowing to a waste storage area, the thermal conductor averages this out and the sample sees basically one temperature over the length of the heat transfer material.

Thermal controllers are typically composed of a bi-metal material similar to what is in a typical home thermostat. Within this realm, there are several similar approaches. One such approach is to mix both the endothermic and exothermic materials together. With proper selection, both materials react with water as a common reagent. The result is a temperature that is accurately adjustable based on the ratio of the two materials. Other thermal controllers can be made from rods that are made from materials with a known coefficient of expansion with temperature. AGA Corporation (from Sweden) used this approach to control acetylene lamps that were used on navigation buoys and for lighting along the Panama Canal. These used a needle valve that had the tip of the needle as one end of a black anodized aluminum rod. When the sun was out and shining on the rod, the rod would expand in length and shut the valve down to a pilot light level of gas flow. At night, the rod would shrink and the valve would open and the light would burn at its maximum brightness. As can be appreciated, there are a number of ways to achieve thermal control. Curved metal can also be used to change the pressure on a valve or to open or close a flexible pipe depending on its expansion and the amount of tension it generates.

In one example, the first thermal agent and second thermal agent are selected to provide an endothermic chemical reaction when they are combined in the second thermal agent storage chamber 74, while the first thermal agent and third thermal agent are selected to provide an exothermic chemical reaction when they are combined in the third thermal agent storage chamber 76. Either one of these endothermic or exothermic chemical reactions can be selected to be provided to the thermal mixing chamber 80 in order to cool or heat the thermal conductor 88, respectively. By cooling or heating the thermal conductor 88, the contents of the sample chamber 72 are similarly cooled or heated.

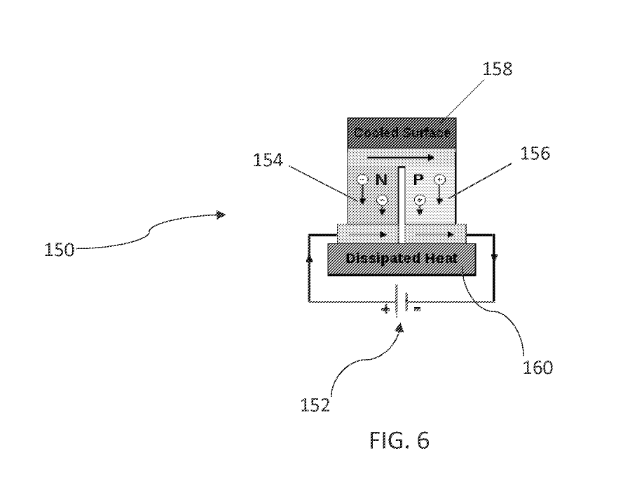

Various types of thermoelectric effects could be incorporated into the designs herein. These could include thermoelectric effects in which a temperature difference creates an electric potential or in which an electric potential creates a temperature difference, or other. For example, a few of these phenomena are known more specifically as the Seebeck effect (converting temperature to current), the Peltier effect (converting current to temperature), and the Thomson effect (conductor heating/cooling). The device 150 shown in FIG. 6 uses the Peltier effect and includes an electrical power source 152, a first metal 154, and a second metal 156. The current shown flowing therethrough (with unlabeled arrows) causes a cooling effect to take place at a surface 158 and in turn dissipates heat at 160. When this device is connected to a voltmeter (or resistive load) instead of a DC power source, it operates as a thermocouple where the voltage emitted is proportional to the temperature of the junction of the N-P conductors. Of course, this reverses the locations where heating and cooling occur, and in that case the surface 158 would be the heat source and the cool side would be at 160.

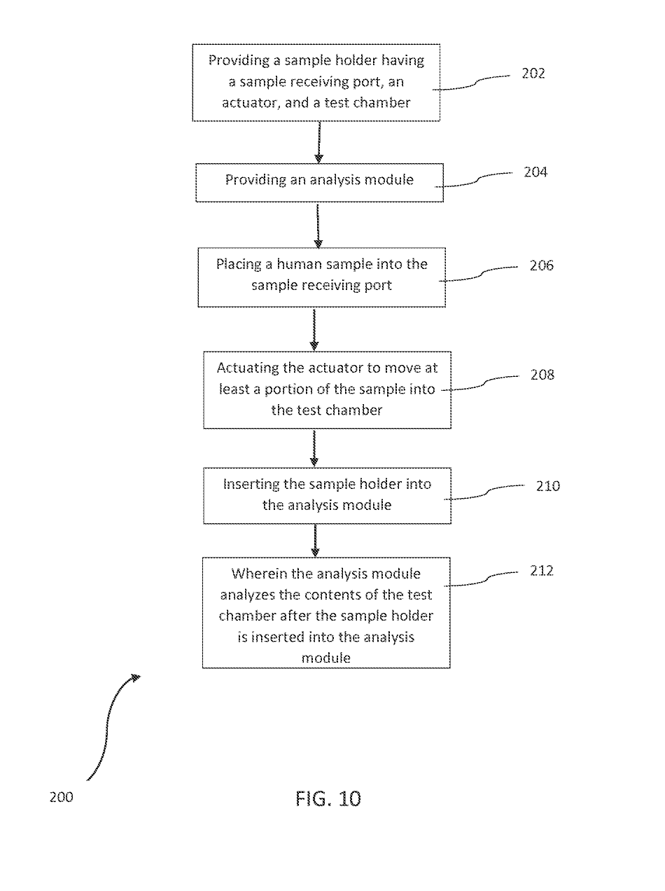

FIG. 10 shows a flowchart of a method 200 for using the sample holders and systems described herein. The method 200 includes providing (202) a sample holder having a sample receiving port, an actuator, and a test chamber, providing (204) an analysis module; placing (206) a human sample into the sample receiving port; actuating (208) the actuator to move at least a portion of the sample into the test chamber; and inserting (210) the sample holder into the analysis module. The analysis module then analyzes (212) the contents of the test chamber after the sample holder is inserted into the analysis module.

Techniques for placing the sample in the sample receiving port will vary depending on the type of sample to be tested. These can include blood samples, as well as mucus and similar samples, and other samples that can be obtained from humans. For blood, one approach is a lancet that would puncture the skin and a capillary next to the lancet that would draw in the required amount of the sample. Other techniques could include a suction function such that, as the lancet is withdrawn, the capillary uses suction to draw in the required amount of blood. For swabs, it is possible to use a hollow shaft such that, when the fluid packet is broken and the reagent flows into the sample receiving port, the fluid flows from outside of the swab, through the swab, and into the shaft. This would require the shaft to have been broken when the swab is inserted into the sample holder and this end would align with the passageway 24 in the sample holder and transport the filtered sample toward the test chambers 28 for analysis. For capturing cells, this could all be operated in reverse, so that the initial washing agent would flow into the broken shaft and through the swab so that any cells captured on the surface of the swab would then be released and would flow into the passageway 24 toward the test chambers 28 for analysis.

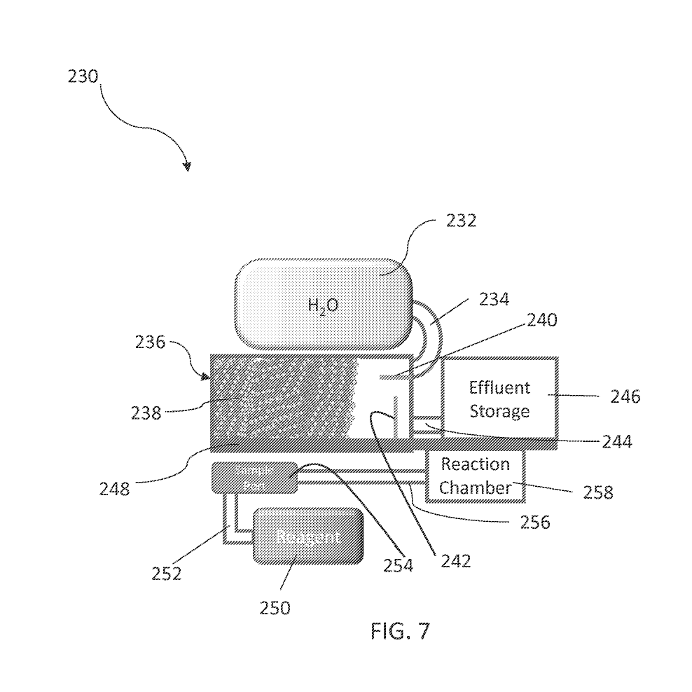

FIG. 7 shows generally an exemplary thermal reaction management system 230 that includes a reservoir of water 232 that can be allowed to flow through the passageway 234 and reservoir 236 of particles or pellets of endothermic material, exothermic material, or a combination of endothermic and exothermic materials in a select ratio. Features 240 and 242 control the flow of water in the reservoir 236 and the movement of the materials 238, to control the flow into a passageway 244 which is connected to effluent storage area 246. The combination of the water 232 with the materials 238 produces a chemical reaction to a reasonably controlled temperature in both the reservoir 236 and the effluent storage area 246. A thermally conductive plate or heat pipe 248 assists in bringing a reaction chamber 258 to the same general temperature. Of course, reagent 250 can be forced through passageway 252, and through a sample port 254 and passageway 256, to bring the combined reagent and sample into the reaction chamber 258. As can be appreciated from other embodiments, the water can flow from the water reservoir into the reservoir 236 via compression, gravity, pressure, valve control, or some other means. There may be a breakable seal allowing the water 232 to leave the water reservoir and passageway 234. Also, the reaction chamber 258 may have reagents therein, waiting for the first reagent and sample to arrive.

There are many alternatives to the specifics discussed herein. For one thing, any of the features shown in FIG. 1 could be incorporated into FIG. 2 and vice versa. For example, the sample holder of FIG. 2 could also have multiple test chambers, and it could also have venting and an overflow reservoir.

There are many ways in which the sample may be introduced into the sample holder. This may include introducing the sample directly into the test chamber. There are also many, many alternatives for how the sample could be moved from the sample receiving port to the test chamber. These could include a mechanical pump, an electrical pump, the use of a magnet, a ferromagnetic fluid, and a flexible membrane between the ferromagnetic fluid and the passageway to urge the fluid along the passageway, and so forth. Alternatively, centrifugal force could be used to derive the fluid in a desired direction within the sample holder.

For example, the sample holder can be designed to be used on a slightly modified CD drive. The drive is spun in one direction and speed to drive the sample into a specific section of the flow system and then in another direction to drive the sample into a different section of the cassette. This can be done many times and reagents can be added in this manner to generate reactions by multiple direction and speed spinning. Such techniques can require a significant amount of power.

Alternatively, fluids can be moved as a result of a chemical reaction. As a simple example, by combining baking soda and vinegar, CO₂ or a similar neutral gas can be generated. The generated gas can provide pressure that can be easily regulated to control the flow of the sample and reagents through a sample holder such as the ones described herein. This could include a layout for a pressure regulating system that controls the generation of the gas so that the reaction is kept under control and can be extended in time to handle the full length of processes. For example, these processes may take up to 30 minutes. In this manner, the amount of material needed, the volume and the cost to produce the gas can be kept to a minimum.

In addition, there could be some type of mechanical means that permits only selected ones of the plurality of test chambers to receive samples while others do not. Further, the valve arrangement and mixing of the endothermic and exothermic products in the thermal mixing chamber could take on many different types of forms. Also, as may be desired for certain processing of the sample prior to analysis, the temperature could be varied manually via operator control of some means to control when the endothermic or exothermic products are introduced into the mixing chamber.

One approach could use slider bars, such that when the operator slides the first one down, it applies pressure to a foil packet of reagent in a manner similar to pressing on the end of a toothpaste tube. As the reagent leaves the packet, the slider bar reaches the end of its travel. At this point, a rod under the cover of the sample holder that has been set to block the operation of the adjacent slider bar is moved out of the way by the first slider bar, thereby releasing the second slider and allowing the processing of the sample to continue in the correct order. In this manner, the system keeps the processing in the correct order and the user cannot inadvertently or purposely make a mistake. With the foil packets providing the correct amount and concentration of reagents and the interlocked bars controlling the order of use, the system is reasonably close to fool proof.

Another approach is similar, but uses twist handles (akin to a faucet handle) instead of slider bars. This allows the system to apply either a positive or negative pressure, providing the ability to acquire a sample (like blood) and to move and mix the sample and reagents. This again can be done with a very high degree of control. The pitch of the thread in each twist handle controls the amount of force that the device generates for each process step. The number of rotations and the pitch control the volume and amount of pressure or suction that is generated. To again control the order of operation, each twist handle has a small plastic filament that runs through the shaft connected to the handle and into the adjacent handle's shaft. In this manner, the next shaft cannot be rotated until the previous one has been rotated and the plastic filament has been retracted. This is done by designing the body around the twist shaft to have a gap between the shaft and housing allowing the plastic filament to be wrapped around the shaft as it is rotated. By affixing the plastic filament on one end to the first shaft, when that shaft is rotated, the plastic filament will wrap around the first shaft and, by the end of the rotating range, the filament is extracted from the next twist handle's shaft and that next twist handle is then free to be rotated. Other shafts can then be chained together in this fashion to prevent the process from being performed other than in the correct order.

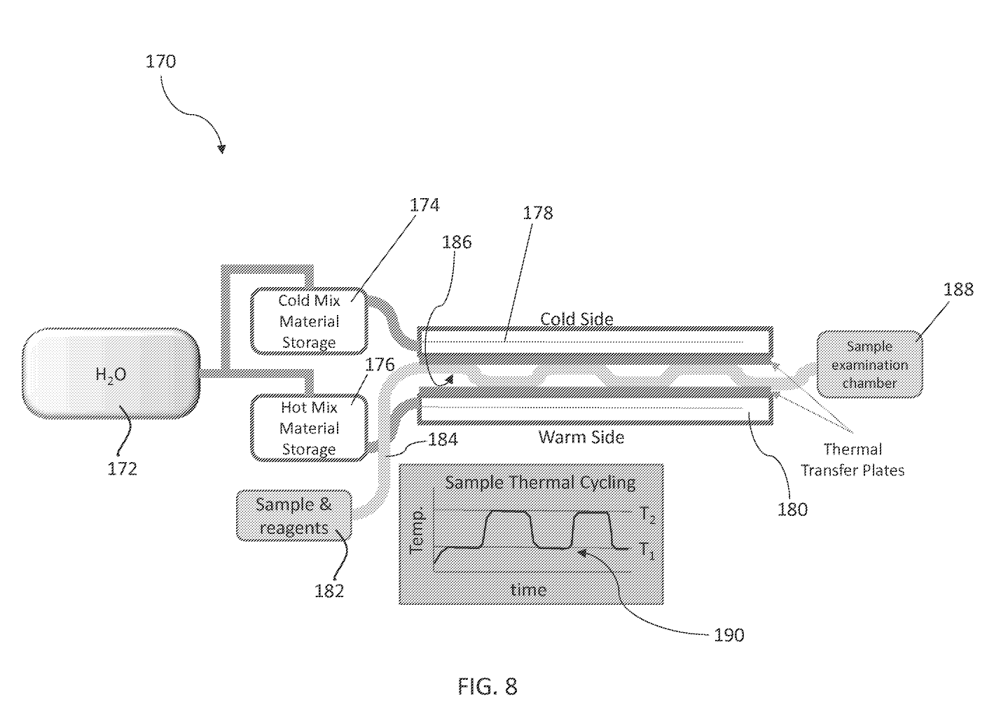

For certain type of chemical reactions prior to analysis, it may be beneficial or helpful to provide for temperature cycling. One example of this may be for a polymerase chain reaction (PCR). A system 170 is shown in FIG. 8 to provide for a simplified type of temperature cycling. A reservoir 172 of water is provided in fluid communication with both a cold mixed material storage area 174 and a hot mix material storage area 176. A combination of the water 72 and the material 174 are provided to a cold side 178 of a temperature cycling area. A combination of the water 72 and the material 176 are provided to a warm side 180 of the temperature cycling area. The desired combination of the sample and reagents 182 are provided via a passageway 184 to the temperature cycling area, where the passageway in this region 186 is curved in a serpentine fashion so that it spends a designed amount of time along the cold side 178 followed by a designed amount of time along the warm side 180. These cycles can be repeated as desired and with controlled flow rates, so as to provide the temperature cycling amounts and times as shown in curve 190.

The temperature is controlled by the ratio of endothermic and exothermic reaction chemicals in the respective storage chambers 174 and 176. Water reacts and flows into the thermal conduction chamber where it transfers its temperature via thermal transfer plates (a portion of the cold side 178 and warm side 180) to the sample. Sample exposure time is set by flow rate and cycling is set by the number of “S” curves in the flow channel between the two thermal transfer plates.

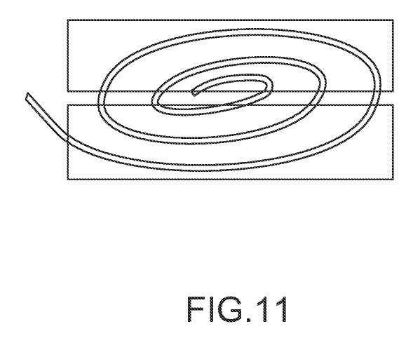

As can be appreciated, there are many types of shapes that a passageway could take through cold and warm regions to achieve the desired temperature cycling. One example of such as shape is shown in FIG. 11. Here, the system 192 also includes a cold side 194 and a warm side 196. In this case, the passageway 198 spirals between the cold side 194 and warm side 196 to achieve the desired temperature cycling.

The disclosed sample holder provide several advantages over the prior art. First, what chemistry that is performed on the sample prior to analysis can be performed in the field via the sample holder. Second, of all, the wet chemistry that is performed is performed internally to the sample holder so that external environmental conditions have little to no impact thereon. Third, the sample holder does not require electrical energy to operate, so batteries or access to electrical power are not necessary. Fourth, the chemistry performed on this sample includes the ability to change the temperature thereof, as needed. Fifth, all of this is performed within a handheld sample holder that can be received by or associated with a portable, digital microscope in the field for analysis.

While the embodiments of the invention have been illustrated and described in detail in the drawings and foregoing description, such illustration and description are to be considered as examples and not restrictive in character. For example, certain embodiments described hereinabove may be combinable with other described embodiments and/or arranged in other ways (e.g., process elements may be performed in other sequences). Accordingly, it should be understood that only example embodiments and variants thereof have been shown and described.

1. A sample holder, comprising:
a sample receiving port;
a test chamber;
a first passageway placing the sample receiving port in fluid communication with the test chamber; and
an actuator associated with the sample receiving port that, when actuated, forces fluid therein into the first passageway and test chamber.

2. A sample holder as defined in claim 1, wherein the sample receiving port has a first volume when in a relaxed state, and wherein the actuator is a mechanical actuator that reduces the volume of the sample receiving port to a volume less than the first volume to force fluid therein into the first passageway and test chamber.

3. A sample holder as defined in claim 2, wherein the mechanical actuator includes a mechanical ram that is sized and positioned to reduce the volume of the sample receiving port when actuated.

4. A sample holder as defined in claim 3, wherein the sample receiving port is defined in a sample holder body and the mechanical ram is associated therewith.

5. A sample holder as defined in claim 4, wherein the mechanical ram is part of a mating body portion that can be actuated relative to the sample holder body to reduce the volume of the sample receiving port.

6. A sample holder as defined in claim 5, wherein the mating body portion is pivotally attached to the sample holder body.

7. A sample holder as defined in claim 5, wherein the mating body portion is pivotally attached to the sample holder body via a hinge.

8. A sample holder as defined in claim 5, wherein the mating body portion and the sample holder body are each part of a clamshell arrangement.

9. A sample holder as defined in claim 3, wherein, when the mechanical actuator is actuated, the mechanical ram is urged by a spring toward the sample receiving port.

10. A sample holder as defined in claim 1, further including a reagent storage chamber containing chemical reagent, the storage chamber being in fluid communication with the sample receiving port via a second passageway containing a pressure-breakable seal;
wherein the actuator includes a mechanical ram that is sized and positioned to reduce the volume of the reagent storage chamber when actuated, which forces reagent into the second passageway, breaks the seal, forces reagent into the sample receiving port, and forces both the reagent and the sample into the first passageway and test chamber.

11. A sample holder as defined in claim 2, further including a particle filter in the first passageway.

12. A sample holder as defined in claim 2, wherein there are a plurality of test chambers all in fluid communication with the first passageway.

13. A sample holder as defined in claim 2, further including an overflow reservoir in fluid communication with the test chamber to receive excess fluid.

14. (canceled)

15. (canceled)

16. (canceled)

17. A sample holder as defined in claim 2, wherein the test chamber has a window to allow the contents therein to be viewed or imaged from the exterior of the sample holder.

18. A sample holder as defined in claim 2, further including:
a first thermal agent storage chamber having a second volume when in a relaxed state, the first thermal agent storage chamber containing a first thermal agent and being in fluid communication with a thermal chamber positioned adjacent to but not in fluid communication with the test chamber, the thermal chamber containing a second thermal agent therein; and
wherein the mechanical actuator, in addition to reducing the volume of the sample receiving port, when actuated, reduces the volume of the thermal agent storage chamber to a volume less than the second volume to force fluid therein into the thermal chamber, the first thermal agent reacting in the thermal chamber with the second thermal agent to create a chemical reaction that changes the temperature of the test chamber.

19. (canceled)

20. (canceled)

21. (canceled)

22. (canceled)

23. (canceled)

24. (canceled)

25. (canceled)

26. (canceled)

27. (canceled)

28. A sample holder as defined in claim 2, wherein the mechanical actuator includes a magnet, a ferromagnetic fluid in an actuation chamber, and a flexible membrane separating the actuation chamber from one or both of the sample receiving port and the first passageway, wherein the magnet selectively acts on the ferromagnetic fluid to deform the membrane and force fluid movement in one or both of the sample receiving port and the first passageway.

29. (canceled)

30. (canceled)

31. (canceled)

32. A sample holder as defined in claim 2, further including a thermal actuator that cycles the temperature of the test chamber between at least two different temperature levels.

33. A sample holder as defined in claim 2, wherein the first passageway passes through at least two different zones in the sample holder that are at different temperature levels from each other.

34. (canceled)

35. (canceled)

36. (canceled)

37. (canceled)

38. (canceled)

39. A sample holder as defined in claim 1, wherein the actuator is a centrifugal actuator associated with the sample receiving port that, when actuated, forces fluid in the sample receiving port into the first passageway and test chamber via centrifugal force.

40. A sample holder as defined in claim 1, wherein the actuator is a gas pressure actuator associated with the sample receiving port that, when actuated, forces fluid in the sample receiving port into the first passageway and test chamber via gas pressure.

41. A sample holder as defined in claim 40, wherein the gas pressure actuator includes two substances that are combined together to cause a chemical reaction that releases gas.

42. A sample holder, comprising:
a test chamber into which a fluid sample can be introduced;
a first thermal agent storage chamber having a first volume when in a relaxed state, the first thermal agent storage chamber containing a first thermal agent and being in fluid communication with a thermal chamber positioned adjacent to but not in fluid communication with the test chamber, the thermal chamber containing a second thermal agent therein; and
a mechanical actuator that, when actuated, reduces the volume of the thermal agent storage chamber to a volume less than the first volume to force fluid therein into the thermal chamber, the first thermal agent reacting in the thermal chamber with the second thermal agent to create a chemical reaction that changes the temperature of the test chamber.

43. A sample holder, comprising:
a sample receiving port;
a test chamber having a first transmissive window on one side of the chamber and a second transmissive window on another side of the chamber; and
a first passageway placing the sample receiving port in fluid communication with the test chamber.

44. (canceled)

45. (canceled)

46. (canceled)

47. (canceled)

48. (canceled)

49. (canceled)

50. (canceled)
